(19) United States
(12) Patent Application Publication
(10) Pub. No.: US 2016/0302460 A1
(43) Pub. Date: Oct. 20, 2016

(54) MARINADE FOR TUMBLING A MEAT PRODUCT

(71) Applicant: Hama Foodservice GesmbH, Hof bei Salzburg (AT)

(72) Inventors: Rudolf HAINDL, Salzburg (AT); Hans MANDL, Pfunds (AT)

(73) Assignee: Hama Foodservice GesmbH, Hof bei Salzburg (AT)

(21) Appl. No.: 15/190,579

(22) Filed: Jun. 23, 2016

Related U.S. Application Data
(63) Continuation of application No. PCT/AT2014/000230, filed on Dec. 23, 2014.

(30) Foreign Application Priority Data
Dec. 27, 2013 (AT) 987/2013

(51) Int. Cl. A23B 7/16; A23L 3/3454

(52) U.S. Cl. CPC A23L 13/72; A23L 27/00; A23L 3/3454

(57) ABSTRACT

A marinade for tumbling a meat product, with water and salt as ingredients, the marinade comprising a milk-based ingredient and gelatine; the marinade may further comprise starch and plum extract. The invention also describes a method for manufacturing a meat product by tumbling, with the steps of comminuting the meat into pieces, introducing the comminuted meat pieces into a tumbling device, introducing a marinade of the invention into the tumbling device onto the comminuted meat pieces, and tumbling the meat pieces in the marinade by rotating the tumbling device. Also claimed is a meat product which comprises at least one meat piece and a marinade of the invention absorbed in the meat piece.

The invention concerns a marinade for tumbling a meat product, with the ingredients water and salt. The invention further concerns a method of producing a meat product by tumbling. Furthermore, the invention concerns a meat product with at least one portion of meat and a marinade absorbed in the portion of meat.

The manufacture of foodstuffs, in particular meat products, is being performed in more and more automated fashion. Initially, mainly intensive livestock farming was responsible for the price per kilo of meat being reduced more and more, the situation nowadays no longer only involves offering a piece of meat which is as good as possible, but also already previously performing some of the further treatment steps which are actually carried out by the purchaser or the user. Thus, it has already long been usual for the meat or pieces of meat to be placed in a marinade. As a result, the meat already receives additional flavors. Furthermore, shelf life can also be positively influenced. In addition, a marinated piece of meat has an inviting effect on a purchaser.

Especially in the case of large-scale producers, so-called tumbling has already long proven its viability for industrial marinating. In that case, the meat or the meat portions are rotated in a large tumbling apparatus together with the marinade, whereby the marinade (sauce) is still better absorbed into the meat. Besides the improvement in taste and the increase in shelf life, that has the additional advantage for the producers that there is an increase in weight, whereby it is possible to achieve a higher price with a smaller proportion of meat. Phosphates have been in use for that purpose for a prolonged period of time, for the greatest possible increase in weight. They are used in the making of sausages, in the making of ham and in tumbling meat applications. The use of phosphates serves to improve the water absorbency and the texture and tenderness in the end product. In the case of fresh meat, the addition of salt in the preparation process serves primarily for taste purposes, phosphate salts in meat products have the essential function of liquid absorption in the meat product. An increase in shelf life is also achieved by virtue of the higher content of antioxidants. In meat processing, the use of phosphate is increasingly subject to scrutiny so that the search for possible alternatives increasingly arose. Phosphates in part have a dubious reputation among nutritional experts and consumers, as they are linked to E-numbers as an additive and have been linked in humans to phosphate intolerances and osteoporosis. For those reasons, endeavors have long been made to totally replace the phosphate, with the proviso of as far as possible achieving the same results. Various different products like transglutaminases have already been tested for that purpose instead of phosphate, but with little success.

The object of the present invention is therefore to provide a marinade which is improved over the state of the art. In particular, the invention aims to dispense with the use of phosphate and nonetheless to achieve a good tumbling result (improvement in taste, increase in shelf life, increase in weight, low cooking loss, more tender meat).

That is achieved by a marinade having the features of claim 1. Accordingly, it is provided that the marinade further contains a milk-based ingredient and gelatin. The milk protein contained in the milk-based ingredient binds the water particularly well. The same applies to the gelatin. As those additional ingredients are relatively neutral in terms of taste, they can be particularly well used as an ingredient for a marinade. A further advantage of those ingredients is the low cooking loss after tumbling. In addition, those ingredients are pure natural products in contrast to phosphate.

Preferably, the marinade contains starch (polysaccharide) as a further ingredient. That starch which is contained in the marinade serves in particular for encapsulation of the meat product. That provides for particularly good pore closure and thus a lower level of cooking loss. It is preferably provided that the starch is produced on the basis of corn.

It is possible to use an acidic milk product, like for example yogurt as the milk-based ingredient. However, it is preferably provided that cream (sweet cream) is used as the milk-based ingredient.

Preferably, the marinade contains a fruit extract with a proportion of sorbitol of over 10% by weight. Such a fruit extract can be produced, for example, on the basis of pears, apples, apricots or peaches as they have a relatively high proportion of sorbitol. It is preferably provided that the fruit extract is a plum extract having a proportion of sorbitol of over 13% by weight. Due to the increased proportion of sorbitol (between 15% and 20%) in the plum extract, that marinade in conjunction with the milk protein of the milk-based ingredient or the cream and the gelatin serves as an effective humectant which can bind water. A further advantage of the plum extract is the improved browning effect when roasting. That means that browning is promoted. A further advantage with the plum extract is that it binds the water by the sorbic acid contained therein. The plum extract can also be referred to as a plum juice concentrate. In principle, other constituents may certainly also be present in that extract or concentrate. Preferably, that extract or concentrate comprises purely the constituents contained in the plums.

Instead of the fruit extract or plum extract or in addition to that fruit or plum extract, the marinade can preferably contain a rosemary extract. That extract serves in particular for shelf life and improved taste. The rosemary extract additionally provides a lower level of susceptibility to mold.

The mixing ratio of the ingredients present should be at least so selected that the marinade can be well used and that no taste extremes occur. Accordingly, is preferably provided that the proportion of water is between 50% and 80% by weight, preferably between 60% and 70% by weight. More specifically, the proportion of water is at about 65% by weight. Naturally, it is to be mentioned here that water is also contained in the other ingredients (in particular in the cream). That weight-% proportion, however, is not meant here but only that proportion of water which is added at the beginning when mixing the ingredients together, as pure water.

It is further preferably provided that the proportion of salt is between 1% and 6% by weight, preferably between 2% and 3.5% by weight. In the specific case, the proportion of salt is 2.78% by weight. In this connection, the term salt is used to mean food-grade salt, cooking salt or table salt which primarily consists of sodium chloride. The salt in the marinade serves not only for taste, but it also opens the meat protein so that the marinade can better penetrate overall into the meat.

In a further preferred embodiment, it is provided that the proportion of starch is between 1% and 5% by weight, preferably between 1.5% and 3% by weight. In the specific case, the proportion of starch is 2.17% by weight.

If the proportion of fruit extract, preferably plum extract, is between 3% and 10% by weight, preferably between 5% and 8% by weight, that provides for particularly good liquid absorption. In the preferred case, the proportion of plum extract is 6.47% by weight. In other words, the proportion of sorbitol in the overall marinade is thus at least 0.3% by weight.

The proportion of rosemary extract to the entire marinade can be kept quite low. Thus, it is for example below 0.01% by weight. In the specific case, the weight percent proportion can be 0.0046%. The marinade, however, can also be rosemary-free.

As the cream and the gelatin have been found to be a particularly good replacement for the phosphates in the tumbling process, it is preferably provided that the proportion of cream and gelatin is together between 15% and 30% by weight, preferably between 20% and 25% by weight, It is preferably provided that the proportion of cream and gelatin is 23.48% by weight. Cream and gelatin also have a preferred weight percent ratio to each other. In that respect, it is provided that the ratio of cream to gelatin is between 99.5 to 0.5 and 97 to 3. As a specific value, the gelatin can have 1.67% by weight of the total mixture as between cream and gelatin. Accordingly, the weight percent proportion of cream is 98.24% by weight. The cream itself in turn is an emulsion of milkfat in water. In that respect, it is preferably provided that the proportion of milkfat to the cream is between 12% and 18% by weight, preferably between 13.5% and 16.5% by weight. In the specific case, the cream has a milkfat proportion of 15%.

A lactose-free cream can also be used as the cream. This means that the cream has no or only a very low proportion (less than 0.1 gram per 100 gram of milk or cream) of milk sugar (lactose). That lactose-free cream can be produced by an enzyme (lactase) being added in the production process, which splits up the milk sugar into galactose and glucose.

Protection is claimed not only for the marinade, but also for a method of producing a meat product by tumbling. In that respect, the steps are comminuting the meat into meat pieces, introducing the comminuted meat pieces into a tumbling apparatus, introducing a marinade according to the invention into the tumbling apparatus for the comminuted meat pieces, and tumbling the meat pieces in the marinade by rotating the tumbling apparatus. By virtue of that method, a very good tumbling result can be achieved even without using phosphate.

It can preferably be provided in this method that the weight percent ratio of meat pieces to marinade is between 70 to 30 and 95 to 5. In the specific case, that wt-% proportion of meat is 80.97%, whereas the wt-% proportion of the marinade is 19.03%. Depending on the kind of meat or the meat pieces used the wt-% proportion of the marinade used can naturally also differ relatively greatly. The meat pieces can come from various kinds of animals. Thus, it is possible to use beef, pork, chicken and turkey, but also fish, shellfish and so forth.

For a particularly good absorption capability, it is provided that the tumbling operation in the tumbling apparatus is carried out at a vacuum of a maximum of 85%.

Depending on the respective kind of meat used and depending on the fundamental absorption capability, it is preferably provided that the tumbling operation in the tumbling apparatus is carried out for between 25 and 100 minutes.

In the production procedure or in the tumbling process, the marinade per se can be cold or hot as desired. However, it is preferably provided that the marinade is introduced into the tumbling apparatus at a temperature of between 3° and 5° C.

Naturally, the starting product used as the meat should be of particularly good quality. It is thus preferably provided that the pH-value of the meat pieces is between 5 and 8, preferably being 7.

To guarantee good penetration of the marinade into the meat pieces and nonetheless not to cause excessive damage to the meat pieces in the tumbling operation, it is preferably provided that the tumbling apparatus rotates at between 5 and 21 revolutions per minute in the tumbling operation.

Protection is however claimed not only for the marinade and for a tumbling method, but also for a meat product comprising at least one meat piece and a marinade according to the invention absorbed in the meat piece. Naturally, in that respect the marinade does not have to be entirely absorbed in the meat piece, but it can also partly surround the at least one meat piece.

As not only the marinade alone has an important influence on the tumbling operation, there are further aspects set forth hereinafter which are important for the invention.

An important basis for phosphate-free tumbling is the meat structure. That is determined by a multiplicity of procedures or starting conditions like the age of the animal, the kind of animal, the speed of cooling after slaughter, the final pH-value and the duration of maturing. All those points have an influence on the final result.

Particularly important points when using the marinade according to the invention are liquid absorption and the cooking or roasting loss. In test series with the marinade according to the invention, it was possible to achieve or even improve on standard criteria without phosphates in terms of liquid absorption and cooking loss. The increase in shelf life is in practice also of significance for trading company chains and restaurateurs and was therefore taken into consideration in development. In specific terms, the best requirements are attained by the following composition:

| | | Weight percent | Weight percent |
|---|---|---|---|
| | | proportion to total | proportion to the |
| Ingredient | Amount | amount | marinade |
| Amount of meat | 13 kg | 80.97% | |
| Water | 1.98 kg | 12.39% | 65.07% |
| Cream + gelatin | 0.717 kg | 4.47% | 23.48% |
| Salt | 0.085 kg | 0.53% | 2.78% |
| Rosemary extract | 0.0014 kg | 0.00087% | 0.0046% |
| Plum extract | 0.197 kg | 1.23% | 6.47% |
| Corn starch | 0.066 kg | 0.41% | 2.17% |

Besides, the nature of the meat and besides the fundamental composition other aspects are also of significance. They are described in greater detail hereinafter.

The phosphate-free use of the marinade is supported by the use of a marinade with cream and gelatin. More specifically, the cream and the gelatin can be used in the form of a food as is known for example from EP 0 805 629 B1. The tenderness and the succulence of the meat pieces are improved by such a marinade. In addition, the marinade may also use whey protein, vegetable fiber (lemon fiber, plum fiber and so forth), starches, fruit spice extracts (for example the powder of dried types of fruits or herbs).

In comparative examples, phosphate brine was also used in the marinade. Particularly if that was added in an excessive amount, that leads to a rubber-like texture for the meat pieces. hat phenomenon could not be found in the case of the marinade according to the invention.

When using the marinade with the meat pieces in known tumbling apparatuses (for example Vacuum Marinator or Turbo Tumbler) which have vacuum systems with up to 95% vacuum, care is to be taken to ensure that the vacuum in the tumbling operation does not exceed between 82 and 83%. Below and above that, it was not possible to find any substantial improvements in products. The duration of the tumbling process should be sufficient at between 30 and 95 minutes (depending on the respective meat piece size). Prolonged periods of time had not caused positive changes in the result. The speed of rotation of the scrapers when rubbing the marinade into the meat pieces should be between 5 and 21 revolutions per minutes. If the speed is too high, the medium is excessively comminuted and loses the natural appearance and shape.

The temperature of the marinade is preferably at between 3° and 5° C. The use of frozen meat is not to be recommended. The pH-value of the meat products should be in the neutral range at a pH-value of 7. If the pH-value should be below that (pH-value of 5), it can be assumed that the meat quality is not particularly well suited to tumbling.

After the vacuum process, it is appropriate for the treated meat which has been portioned in smaller or larger pieces to be allowed to mature for 24 hours in a cold store at between 3° and 5° C. Before the cooking process, the meat should be as dry as possible at the outside, the loss of liquid when roasting the meat pieces is then correspondingly less and more efficient.

Raw materials are used in the marinade, which by virtue of their high proportion of antioxidants are firstly a natural ingredient and guarantee for the producer microbiological security when processing and storing raw or pre-cooked meat products. In addition, protection from unwanted flavors due to re-heating products which have a high fat content and keeping them warm is made possible.

By virtue of the natural content of antioxidants, the marinade according to the invention can be used for extending the shelf life of meat goods. The antioxidants prevent unsaturated fatty acids in raw or pre-cooked meat products from becoming rancid. In addition, the antioxidants effectively suppress the growth of pathogens like salmonellas, coliform bacteria and listeria. In addition, the natural content of sorbitol reinforces the water binding effect, which is reflected in a juicy taste and reduces the loss of salt upon cooking.

For the most part, meat which has been subjected to a tumbling process for liquid absorption is then heated. One of the most important reasons for heating (besides taste and tenderness) involves killing off any microorganisms that may be present. They are inactivated at a temperature of 55° C. Therefore, in accordance with HACCP requirements, meat is heated to a core temperature of 75° C. in order to be entirely sure.

Meat which is heated loses more and more liquid (water) and fat with increasing heating. In the case of prolonged heating at over 100° C., up to 48% of roasting loss can occur. The roasting losses are also more or less dependent on the pH-value, depending on the respective kind of meat.

Upon heating it is firstly the myofibrillar proteins that shrink. From between about 60° and 75° C., the connective tissue is denatured. As shrinkage signifies water being urged out the fibrillar structures which immobilize about 85% water of the muscle, increasingly more water issues from the meat at those temperatures. Upon shrinkage, the meat in the normal case becomes tougher, therefore it is important to pre-treat the meat structure (protein) to reduce that effect or indeed entirely eliminate it.

No difference in treatment of the meat samples was found in sensory test series by virtue of rubbing in the marinade according to the invention, in comparison with traditional phosphate mixtures.

In a specific test, chicken meat was tumbled in a tumbling apparatus with a vacuum of 82% on the one hand in a marinade according to the invention and on the other hand in a marinade with phosphate for 45 minutes. After a period of 30 minutes, the increase in weight was about 13% with both marinades. After 45 minutes, the increase in weight with the marinade according to the invention was 17.95% while it was 30.73% with the phosphate. After that, the chicken meat was roasted for three hours at a core temperature of 65° C. In that case, with the marinade according to the invention, the loss in weight was only 7.5%, while with the phosphate marinade it was 15.72%.

The same process was also carried out with veal. After 45 minutes, the increase in weight in the tumbling operation with the marinade according to the invention was 23.13%, while with the phosphate marinade it was 25.32%. The roasting loss with the marinade according to the invention was particularly low in comparison with the phosphate marinade. That was 20.59% in comparison with 30.67% with the phosphate marinade.

The same tumbling operation and the same roasting was also carried out with pork. The increase in weight with the marinade according to the invention was 15.58%, while it was 28.57% with the phosphate marinade. In this case, also the roasting loss was substantially better with the marinade according to the invention. It was only 18.92%, while with the phosphate marinade it was 24.11% after roasting for 3 hours at a core temperature of 65° C.

The cell structure of meat and fish is very delicate and for that reason with any organic substance, high temperatures can quickly cause great damage thereto. Cooking methods have been the subject of further development in the passage of time. In that respect, there is the appropriate equipment for each cooking method. The new appliances and kitchen technology (sous vide) open up new possible ways of reducing the roasting loss. As far as possible, that loss is reduced or cut down with the tumbling process.

In principle, raw meat involves a highly ordered structure. Three connective tissue layers additionally enclose muscle, muscle fiber bundles and muscle fibers. Raw meat has a high level of elasticity and strength so that meat is difficult to sever when biting into it. The highly ordered structure also means that substances like salt and so forth can only penetrate with difficulty. In addition, penetration is resisted by the lipid bilayer of the cell membranes which admittedly slowly dissolve but which are always still there.

Comminuting, cutting, crushing, tearing and mincing destroy that ordered structure. Both the roasting loss and also contamination of the meat pieces is quicker due to comminution (larger surface area). The roasting loss and the shelf life can be positively influenced by introducing the marinade according to the invention with a proportion of between 5% and 15% of oxidants into a tumbler. At the same time, it was found that drying out the surface prior to browning can reduce the roasting loss. The best results were achieved with the following procedure:

The meat pieces should firstly be as dry as possible at the outside. It is also advantageous if the meat is placed on a grid overnight in the cold store at between 3° and 5° Celsius.

The meat is then removed and uniformly spread on a greased roasting sheet or on a roasting tray and browned at all sides at between 220° and 300° Celsius for 3-5 minutes. With that browning process, the roasting loss remains substantially lower (between 2.5% and 4%) than with conventional uses.

The browned meat is then sealed in vacuum bags or vacuum dishes which are provided with a cover, with 90% vacuum. The bags or dishes with the meat are then cooked over a prolonged period in a water bath or using steam at between 58° and 75° Celsius. That cooking method has the advantage that the meat does not come into contact with water. As a result, there is no loss of taste and there are no reductions in quality. The low temperature cooking over a prolonged period and the use of the phosphate-free marinade according to the invention meant that it was possible to substantially improve the quality of the meat like the regenerability of precooked meat dishes cooled to 5° Celsius.

1. A marinade for tumbling a meat product, with the ingredients water and salt, characterized in that the marinade further contains a milk-based ingredient and gelatin.

2. The marinade according to claim 1, wherein the marinade contains starch, preferably based on corn.

3. The marinade according to claim 1, wherein the milk-based ingredient is cream.

4. The marinade according to claim 1, wherein the marinade contains a fruit extract with a proportion of sorbitol of over 10% by weight.

5. The marinade according to claim 4, wherein the fruit extract is a plum extract with a proportion of sorbitol of over 13% by weight.

6. The marinade according to claim 1, wherein the marinade contains a rosemary extract.

7. The marinade according to claim 1, wherein the proportion of water is between 50% and 80% by weight, preferably between 60% and 70% by weight.

8. The marinade according to claim 1, wherein the proportion of salt is between 1% and 6% by weight, preferably between 2% and 3.5% by weight.

9. The marinade according to claim 2, wherein the proportion of starch is between 1% and 5% by weight, preferably between 1.5% and 3% by weight.

10. The marinade according to claim 4, wherein the proportion of fruit extract, preferably plum extract, is between 3% and 10% by weight, preferably between 5% and 8% by weight.

11. The marinade according to claim 3, wherein the proportion of cream, together with gelatin, is between 15% and 30% by weight, preferably between 20% and 25% by weight.

12. The marinade according to claim 11, wherein the ratio of cream to gelatin is between 99.5 to 0.5 and 97 to 3.

13. The marinade according to claim 1, wherein the, preferably lactose-free, cream is an emulsion of milkfat in water and the proportion of milkfat to the cream is between 12% and 18% by weight, preferably between 13.5% and 16.5% by weight.

14. A method of producing a meat product by tumbling, including the steps:
comminuting the meat into meat pieces,
introducing the comminuted meat pieces into a tumbling apparatus,
introducing a marinade according to claim 1 into the tumbling apparatus for the comminuted meat pieces, and
tumbling the meat pieces in the marinade by rotating the tumbling apparatus.

15. The method according to claim 14, wherein the weight percent ratio of meat pieces to marinade is between 70 to 30 and 95 to 5.

16. The method according to claim 14, wherein tumbling in the tumbling apparatus is carried out at a vacuum of a maximum of 85%.

17. The method according to claim 14, wherein tumbling in the tumbling apparatus is carried out for between 25 and 100 minutes.

18. The method according to claim 14, wherein the marinade is introduced into the tumbling apparatus at a temperature of between 3° and 5° C.

19. The method according to claim 14, wherein the pH-value of the meat pieces is between 5 and 8, preferably being 7.

20. The method according to claim 14, wherein the tumbling apparatus rotates at between 5 and 21 revolutions per minute in the tumbling operation.

21. A meat product having at least one meat piece and a marinade according to claim 1 absorbed in the meat piece.
